(19) United States
(12) Patent Application Publication
(10) Pub. No.: US 2008/0181305 A1
(43) Pub. Date: Jul. 31, 2008

(54) APPARATUS AND METHOD OF ENCODING VIDEO AND APPARATUS AND METHOD OF DECODING ENCODED VIDEO

(75) Inventors: Dae-Sung CHO, Seoul (KR); Woo-Shik Kim, Yongin-si (KR); Dmitri Birinov, Yongin-si (KR); Hyun-Mun Kim, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/014,571

(22) Filed: Jan. 15, 2008

Related U.S. Application Data
(63) Continuation of application No. PCT/KR2006/002791, filed on Jul. 14, 2006.

(30) Foreign Application Priority Data
Jul. 15, 2005 (KR) 10-2005-0064504

(51) Int. Cl. H04N 7/12

(52) U.S. Cl. 375/240.12; 375/240.01; 375/E07.243

(57) ABSTRACT

A method and apparatus for encoding a video and a method and apparatus for decoding the encoded video are provided. The video encoding apparatus includes: an encoding unit encoding a main image and an auxiliary image and generating encoded main image data and encoded auxiliary image data; and a bitstream packing unit combining the encoded auxiliary image data to the encoded main image data and thus packing the data as one bitstream. The video decoding apparatus includes: a bitstream unpacking unit unpacking a bitstream packed by combining encoded auxiliary image data to encoded main image data, and separating the encoded main image data and the encoded auxiliary image data; and a decoding unit decoding the separated encoded main image data and auxiliary image data and generating a restored image.

### CROSS-REFERENCE TO RELATED PATENT APPLICATION

This application is a continuation of International Application No. PCT/KR2006/002791, filed Jul. 14, 2006, and claims the benefit of Korean Patent Application No. 10-2005-0064504, filed on Jul. 15, 2005, in the Korean Intellectual Property Office, the disclosures of which are incorporated herein in their entirety by reference.

### BACKGROUND OF THE INVENTION

1. Field of the Invention

The present invention relates to video encoding and decoding, and more particularly, to an apparatus and a method by which a main image and an auxiliary image are encoded and generated as a bitstream, by using an identical encoding scheme, and the generated bitstream is decoded using an identical decoding scheme.

2. Description of the Related Art

In general, when an image is compressed, the image format of R, G, and B components that can be directly obtained from a multimedia apparatus is transformed into an image format composed of a luminance component, i.e., a Y component, and chrominance components, i.e., Cb and Cr components, which is suitable for compression. Then, in order to increase the efficiency of compression, the chrominance components Cb and Cr are additionally reduced to one fourth, respectively, and encoding and decoding are performed. A leading example of this encoding and decoding method may be a VC-1 video compression technology suggested by the Society of Motion Picture and Television Engineers (SMPTE) (Refer to “Proposed SMPTE Standard for Television: VC-1 Compressed Video Bitstream Format and Decoding Process”, SMPTE42M, FCD, 2005).

However, in order to provide efficient services relevant to images, this video compression technology requires a function for synthesizing and editing auxiliary information items, such as gray shape information, between images. Here, the auxiliary information other than the luminance component and chrominance components is image information required in order to process image information formed with the luminance component and chrominance components, so that the image information can be made suitable for an application device desired to be used.

### SUMMARY OF THE INVENTION

The present invention provides an apparatus and a method of encoding a video by which a main image and an auxiliary image are encoded and generated as a bitstream by using an identical encoding scheme.

The present invention also provides an apparatus and a method of decoding a video by which encoded main image data and encoded auxiliary image data separated from a bitstream generated by encoding a main image and an auxiliary image are decoded using an identical decoding scheme.

According to an aspect of the present invention, there is provided an apparatus for encoding a video including: an encoding unit encoding a main image and an auxiliary image and generating encoded main image data and encoded auxiliary image data; and a bitstream packing unit combining the encoded auxiliary image data to the encoded main image data and thus packing the data as one bitstream.

According to another aspect of the present invention, there is provided a method of encoding a video including encoding a main image and an auxiliary image and generating encoded main image data and encoded auxiliary image data; and according to an external control signal, determining whether or not to combine the encoded main image data with the encoded auxiliary image data, and packing the data as one bitstream.

According to another aspect of the present invention, there is provided an apparatus for decoding a video including: a bitstream unpacking unit unpacking a bitstream packed by combining encoded auxiliary image data to encoded main image data, and separating the encoded main image data and the encoded auxiliary image data; and a decoding unit decoding the separated encoded main image data and auxiliary image data and generating a restored image.

According to another aspect of the present invention, there is provided a method of decoding a video including: unpacking a bitstream packed by combining encoded auxiliary image data to encoded main image data, and separating the encoded main image data and the encoded auxiliary image data; and decoding the separated encoded main image data and auxiliary image data and generating a restored image.

The video encoding method and decoding method may be realized as computer codes stored on a computer-readable recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a structure of a video encoding apparatus according to an embodiment of the present invention;

FIG. 2 is a block diagram illustrating a detailed structure of a luminance component encoding unit illustrated in FIG. 1 according to an embodiment of the present invention;

FIG. 3 is a block diagram illustrating a structure of a video decoding apparatus according to an embodiment of the present invention;

FIG. 4 is a block diagram illustrating a detailed structure of a luminance component decoding unit illustrated in FIG. 3 according to an embodiment of the present invention;

FIG. 5 is a diagram illustrating a format of an image signal input to a video encoding apparatus according to an embodiment of the present invention;

FIGS. 6A and 6B are diagrams illustrating structures of a slice and a macroblock according to an embodiment of the present invention;

FIG. 7A is a diagram illustrating a structure of a bitstream generated as a result of encoding a frame-type main image without an auxiliary image and FIG. 7B is a diagram illustrating a structure of a bitstream generated as a result of encoding a frame-type main image with an auxiliary image according to an embodiment of the present invention;

FIGS. 8A through 8C are diagrams illustrating relations between frame-type main images and auxiliary images according to an embodiment of the present invention;

FIG. 9A is a diagram illustrating a structure of a bitstream generated as a result of encoding a field-type main image without an auxiliary image and FIGS. 9B and 9C are diagrams illustrating structures of bitstreams generated as results of encoding a field-type main image with an auxiliary image according to an embodiment of the present invention;

FIGS. 10A through 10E are diagrams illustrating relations between field-type main images and auxiliary images according to an embodiment of the present invention;

FIG. 11A is a diagram illustrating a structure of a bitstream generated as a result of encoding a slice-type main image without an auxiliary image and FIGS. 11B and 11C are diagrams illustrating structures of bitstreams generated as results of encoding a slice-type main image with an auxiliary image according to an embodiment of the present invention;

FIGS. 12A and 12B are diagrams illustrating relations between slice-type main images and auxiliary images according to an embodiment of the present invention; and

FIG. 13 is a diagram illustrating an example of image synthesis using a gray alpha image as an example of an auxiliary image according to an embodiment of the present invention.

### DETAILED DESCRIPTION OF THE INVENTION

The present invention will now be described more fully with reference to the accompanying drawings, in which exemplary embodiments of the invention are shown.

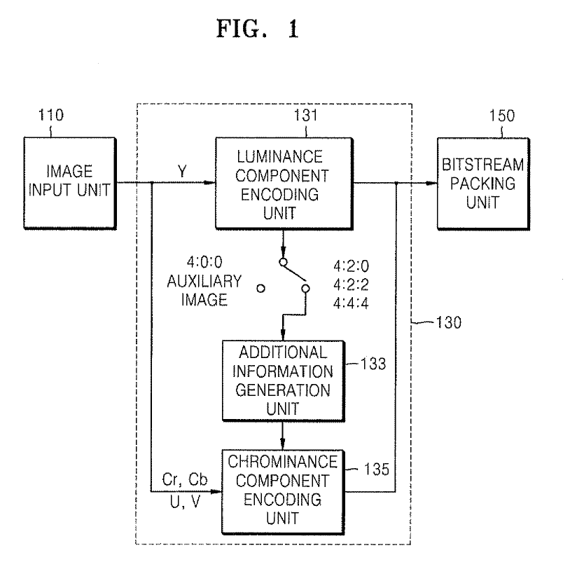

FIG. 1 is a block diagram illustrating a structure of a video encoding apparatus according to an embodiment of the present invention. The video encoding apparatus is composed of an image input unit 110, an encoding unit 130, and a bitstream packing unit 150. Here, the encoding unit 130 is composed of a luminance component encoding unit 131, an additional information generation unit 133 and a chrominance component encoding unit 135.

Referring to FIG. 1, the image input unit 110 receives inputs of a main image and an auxiliary image, and separates the luminance component and chrominance components of the main image according to an image format. Here, the main image may have any one image format of a 4:0:0 format, a 4:2:0 format, a 4:2:2 format, and a 4:4:4 format. Meanwhile, the auxiliary image can be used for editing or synthesizing, or for generating a 3-dimensional (3D) image, or for providing error resilience. An example of the auxiliary image for editing or synthesizing may a gray alpha image. An example of the auxiliary image for generating a 3D image may be a depth image having the depth information of a main image. An example of the auxiliary image for providing the error resilience may be an image the same as a main image. The examples of the auxiliary image are not limited to the above, and various images may be adapted for the auxiliary image.

The encoding unit 130 encodes the main image or auxiliary image provided from the image input unit 110 according to an identical coding scheme. The luminance component encoding unit 131 encodes the luminance component of the input main image or auxiliary image. The additional information generation unit 133 generates additional information, such as a motion vector obtained through motion prediction in the luminance component encoding unit 131. The chrominance component encoding unit 135 encodes the chrominance components of the main image by using the additional information generated in the additional information generation unit 133. In the encoding unit 130, according to whether the input image is a main image or an auxiliary image, and in the case of the main image, according to the image format it is determined whether only the luminance component is to be encoded or both the luminance component and the chrominance components are to be encoded. That is, if the image input to the encoding unit 130 is a main image and has any one image format among a 4:2:0 format, a 4:2:2 format, and a 4:4:4 format, the luminance component and chrominance components of the image are encoded. Meanwhile, if the image input to the encoding unit 130 is a main image and has a 4:0:0 format, or if the image is an auxiliary image, only the luminance component is encoded. Meanwhile, if an image the same as a main image is used as an auxiliary image for providing the error resilience, only the luminance component or both the luminance component and the chrominance components may be encoded for the auxiliary image. This information on the type and format of the image and component to be encoded may be provided through the image input unit 110 or may be set in advance by a user and determines the operation of the encoding unit 130.

The bitstream packing unit 150 combines the encoded main image data and auxiliary image data provided from the encoding unit 130 and packages the data as one bitstream. At this time, whether or not to combine the data may be determined according to an external control signal. Here, the external control signal may be generated by a user input, a request from a video decoding unit, or the situation in a transmission channel, but is not limited to these. For example, if the user determines that the auxiliary image data is not necessary, or if a message transmitted by a video decoding apparatus that the video decoding apparatus cannot handle the auxiliary image data due to the limit of the performance of the apparatus is received, or if information that a transmission channel is in a poor state is received, the encoded auxiliary image data is not combined and the bitstream is packaged using the encoded main image data.

Elements included in a bitstream generated by the bitstream packing unit 150 illustrated in FIG. 1 are defined as the following Table 1.

TABLE 1

| Data type | Field name | Meaning |
|---|---|---|
| Sequence | SEQ_SC | Information indicating the |
| Start Code | | start position of a |
| | | sequence of a plurality of |
| | | images |
| Sequence Header | SEQ_HEADER | Header information |
| | | indicating the |
| | | characteristic of an entire |
| | | sequence |
| Entry Point | ENTRY_SC | Information indicating the |
| Start Code | | start position of GOP that |
| | | is a basic unit of images |
| | | forming a sequence that |
| | | can be randomly access |
| Entry Point | ENTRY_HEADER | Header information |
| Header | | including information |
| | | enabling random access |
| Frame Start | FRAME_SC | Information indicating the |
| Code | | start position of a frame |
| | | image |
| Frame Data | FRAME_DATA | Frame image encoding |
| | | data processed in units of |
| | | macroblocks and including |
| | | frame header information |
| Field Start | FIELD_SC | Information indicating the |
| Code | | start position of a field |
| | | image |
| Field Data 1 | FLD1_DATA | Field image encoding data |
| | | processed in units of |
| | | macroblocks and including |
| | | frame header information |
| Field Data 2 | FLD2_DATA | Field image encoding data |
| | | processed in units of |
| | | macroblocks and including |
| | | field header information |
| Slice Start | SLC_SC | Information indicating the |
| Code | | start position of a slice |
| Slice Data | SLC_DATA | Encoding data information |
| | | of a slice formed with a |
| | | plurality of macroblocks |
| | | and including slice header |
| | | information |
| Auxiliary Start | AUXILIARY_SC | Information indicating the |
| Code | | start position of an |
| | | auxiliary image |
| Auxiliary Data | AUXILIARY_DATA | Auxiliary image encoding |
| | | data corresponding to |
| | | FRAME_DATA |
| Auxiliary Data | AUXILIARY1_DATA | Auxiliary image encoding |
| | | data corresponding to |
| | | FLD1_DATA |
| Auxiliary Data | AUXILIARY2_DATA | Auxiliary image encoding |
| | | data corresponding to |
| | | FLD2_DATA |
| Auxiliary Data | AUXILIARY3_DATA | Auxiliary image encoding |
| | | data corresponding to |
| | | SLC_DATA |

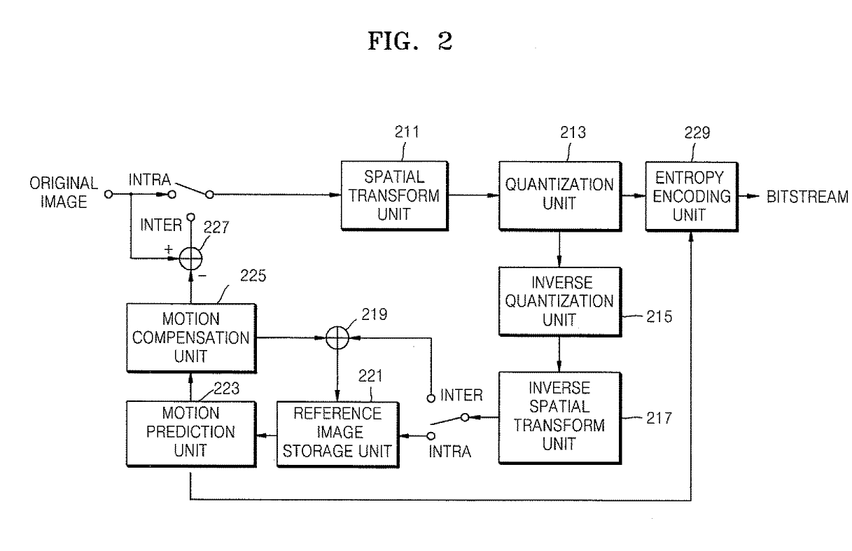

FIG. 2 is a block diagram illustrating a detailed structure of the luminance component encoding unit 131 of the encoding unit 130 illustrated in FIG. 1 according to an embodiment of the present invention. The luminance component encoding unit 131 is composed of a spatial transform unit 211, a quantization unit 213, an inverse quantization unit 215, an inverse spatial transform unit 217, an addition unit 219, a reference image storage unit 221, a motion prediction unit 223, a motion compensation unit 225, a subtraction unit 227, and an entropy encoding unit 229. In order to increase the efficiency of encoding, the encoding unit 130 applies an inter mode in which a transform coefficient is predicted by estimating motion in units of blocks between a previous frame and a current frame, and an intra mode in which a transform coefficient is predicted from a block spatially adjacent to a current block within a current frame. Preferably, ISO/IEC MPEG-4 video encoding international standards or H.264/MPEG-4 pt. 10 AVC standardization technologies of JVT of ISO/IEC MPEG and ITU-T VCEG may be employed.

The spatial transform unit 21 performs frequency domain transform, such as discrete cosine transform (DCT), Hadamard transform, or integer transform, with respect to a current image in an intra mode, and in an inter mode, performs frequency domain transform with respect to a temporal prediction error that is a difference image between a current image and a motion compensated image of a previous reference image. The quantization unit 213 performs quantization of transform coefficients provided from the spatial transform unit 211 and outputs quantization coefficients.

The inverse quantization unit 215 and the inverse spatial transform unit 217 perform inverse quantization and inverse spatial transform, respectively, of the quantization coefficients provided from the quantization unit 213. A current image restored as the result of the space inverse transform is stored without change, in the reference image storage unit 221 in an intra mode, and in an inter mode, the restored current image is added to an image motion compensated in the motion compensation unit 225, and then the added result is stored in the reference image storage unit 221.

The motion prediction unit 223 and the motion compensation unit 225 perform motion prediction and motion compensation, respectively, with respect to the previous reference image stored in the reference image storage unit 221, and generate the motion compensated image.

The entropy encoding unit 229 entropy-encodes additional information, such as quantization coefficients provided from the quantization unit 213 and motion vectors output from the motion prediction unit 223, and thus generates a bitstream.

Meanwhile, since additional information, such as motion vectors, is provided, the chrominance component encoding unit 135 illustrated in FIG. 1 can be easily implemented by removing the motion prediction unit 223 among the elements of the luminance component encoding unit 133.

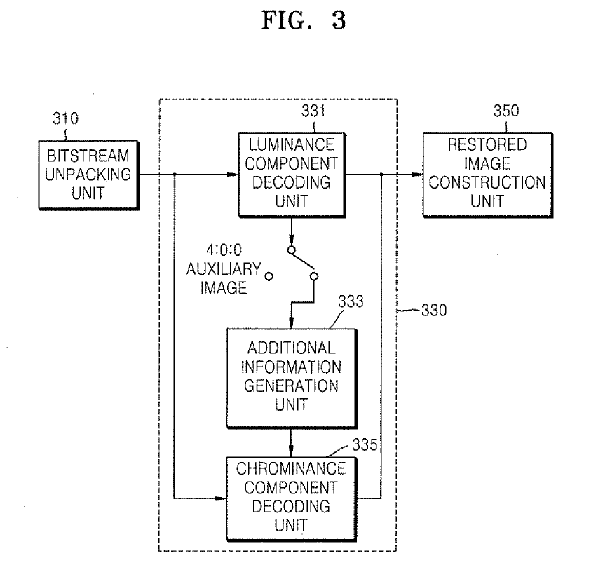

FIG. 3 is a block diagram illustrating a structure of a video decoding apparatus according to an embodiment of the present invention. The video decoding apparatus is composed of a bitstream unpacking unit 310, a decoding unit 330, and a restored image construction unit 350. Here, the decoding unit 330 includes a luminance component decoding unit 331, an additional information generation unit 333, and a chrominance component decoding unit 335.

Referring to FIG. 3, the bitstream unpacking unit 310 unpacks a bitstream provided through a transmission channel or a storage medium, and separates encoded main image data and encoded auxiliary image data.

The decoding unit 330 decodes the encoded main image data or the encoded auxiliary image data provided from the bitstream unpacking unit 310, according to an identical decoding scheme. The luminance component decoding unit 331 decodes the luminance component of the encoded main image data or the encoded auxiliary image data. The additional information generation unit 333 generates additional information, such as motion vectors used for motion compensation in the luminance component encoding unit 331. The chrominance component decoding unit 335 decodes the chrominance components of the encoded main image data by using the additional information generated in the additional information generation unit 333. In the decoding unit 330, according to the type of the image data and the format of images obtained from the header of the bitstream, it is determined whether or not only the luminance component is to be decoded or both the luminance component and the chrominance components are to be decoded. That is, if the encoded image data input to the decoding unit 330 is a main image and has any one image format of a 4:2:0 format, a 4:2:2 format, and a 4:4:4 format, the luminance component and the chrominance components are decoded. Meanwhile, if the encoded image data input to the decoding unit 330 is a main image and has a 4:0:0 format or the data is an auxiliary image, only the luminance component is decoded.

The restored image construction unit 350 constructs a final restored image, by combining the main image and auxiliary image decoded in the decoding unit 330. Here, the restored image may be any one of an edited or synthesized image, a 3D image, and an image replacing a main image when an error occurs in the main image. This restored image can be effectively used in a variety of application fields by broadcasting or contents authors.

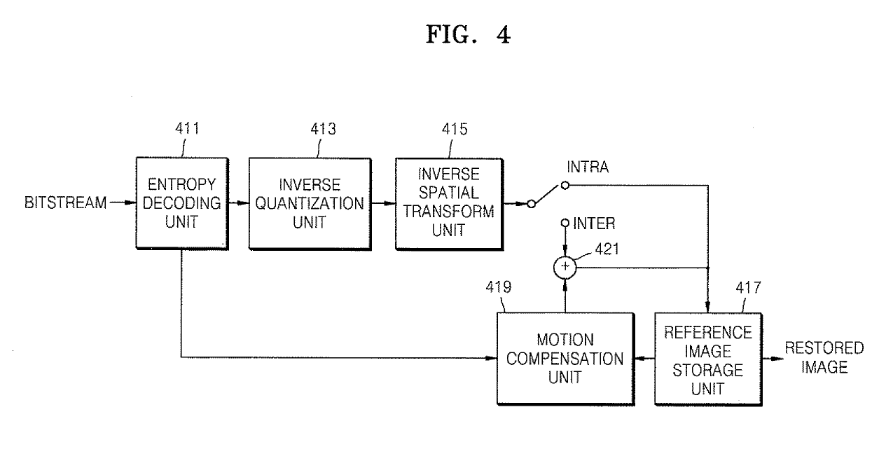

FIG. 4 is a block diagram illustrating a detailed structure of the luminance component decoding unit 331 of the decoding unit 330 illustrated in FIG. 3 according to an embodiment of the present invention. The luminance component decoding unit 331 is composed of an entropy decoding unit 411, an inverse quantization unit 413, a inverse spatial transform unit 415, a reference image storage unit 417, a motion compensation unit 419, and an additional unit 421.

Referring to FIG. 4, the entropy decoding unit 411 entropy-decodes the main image data or auxiliary image data separated in the bitstream unpacking unit 310 and extracts quantization coefficients and additional information.

The inverse quantization unit 413 and the inverse spatial quantization unit 415 perform inverse quantization and inverse spatial transform, respectively, with respect to the quantization coefficients extracted in the entropy-decoding unit 411. In an intra mode, the restored current image is directly stored in the reference image storage unit 417, and in an inter mode, the restored current image is added to a motion compensated image of a previous reference image, and the addition result is stored in the reference image storage unit 417.

The motion compensation unit 419 generates the motion compensated image of the previous reference image, by using additional information provided from the entropy decoding unit 411.

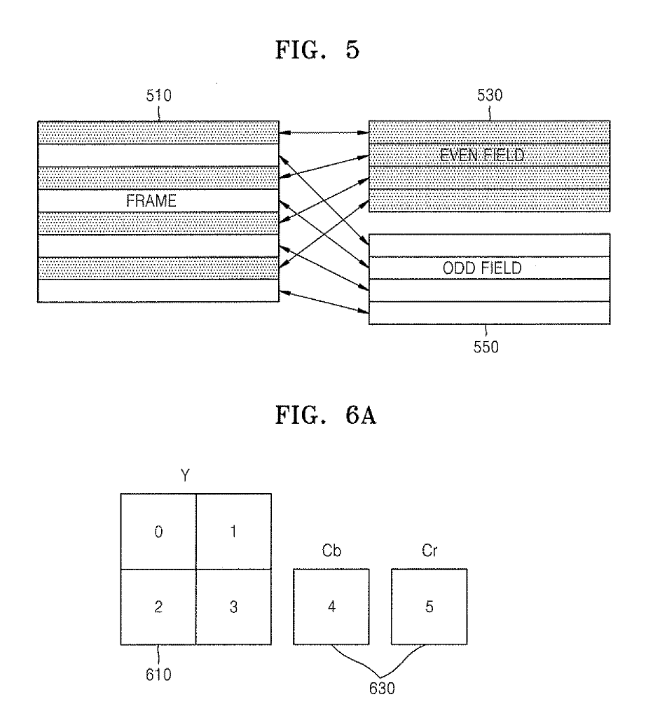

FIG. 5 is a diagram illustrating types of an image input to a video encoding apparatus according to an embodiment of the present invention. FIG. 5A illustrates a frame-type image and FIG. 5B illustrates a field-type image. The frame-type image is formed with even fields and odd fields, while the field-type image is formed by separately collecting even fields or odd fields.

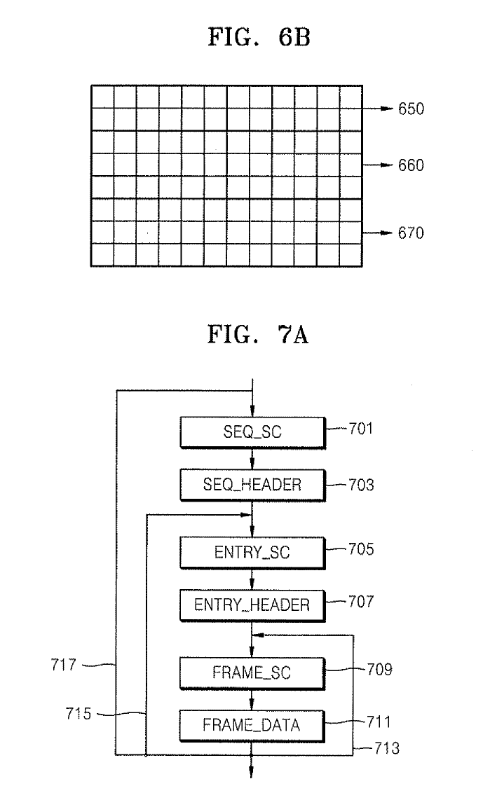

FIG. 6 is a diagram illustrating structures of a slice and a macroblock. Here, a macroblock is a unit of processing an image, and, for example, a luminance component may be set as a macroblock of 16×16 pixels, and a chrominance component may be set as a macroblock of 8×8 pixels. Meanwhile, a slice is formed with a plurality of macroblocks. When a compressed bitstream is transmitted through a transmission channel or stored in a storage medium, and then, later the bitstream is used, an error may occur in the image data. In this case, in order to prevent the error occurred in part of the image data from spreading over the entire image data, the entire image data is divided into a plurality of macroblocks, i.e., a slice, and separately encoded.

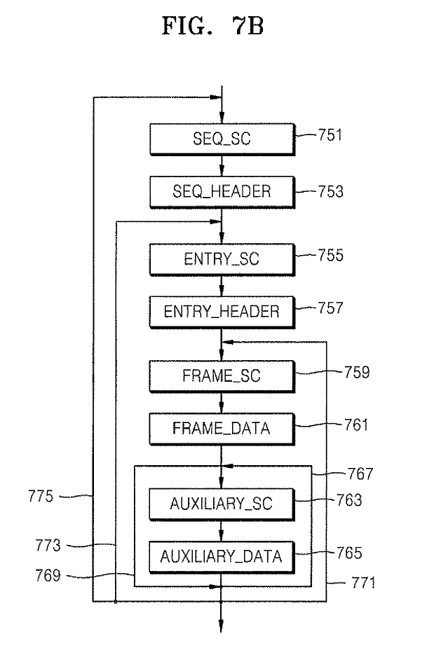

FIGS. 7A and 7B illustrate structures of bitstreams generated by the bitstream packing unit 150 illustrated in FIG. 1. FIG. 7A is a diagram illustrating a structure of a first bitstream generated as a result of encoding a frame-type main image without an auxiliary image and FIG. 7B is a diagram illustrating a structure of a second bitstream generated as a result of encoding a frame-type main image with an auxiliary image according to an embodiment of the present invention.

Referring to the structure of the first bitstream illustrated in FIG. 7A, a SEQ_SC field 701 and a SEC_HEADER field 703 are positioned before other data in the sequence. After information indicating the sequence, an ENTRY_SC field 705 and an ENTRY_HEADER field 707 are positioned in order to distinguish a group of pictures (GOP) and to support random access. After these fields, data 713 corresponding to a plurality of frame images of a main image are positioned. Data corresponding to each frame image is formed with a FRAME_SC field 709 and a FRAME_DATA field 711. After one GOP is constructed, other existing GOPs 715 are repeatedly constructed. Also, after one sequence is constructed, other existing sequences 717 are repeatedly constructed.

Meanwhile, in order to construct the second bitstream by including an auxiliary image into the structure of the first bitstream, an independent area for the auxiliary image is defined using the AUXILIARY_SC field and the AUXILIARY_DATA so field illustrated in table 1, after the frame images that are the main image. The AUXILIARY_SC field is a field indicating the start position of the auxiliary image and corresponds to an auxiliary image distinguishing signal enabling distinction from a main image. The AUXILIARY_DATA field is a field indicating encoded auxiliary image data, and includes header information expressing an auxiliary image and encoded auxiliary image data.

Referring to the structure of the second bitstream illustrated in FIG. 7B, a SEQ_SC field 751 and a SEC_HEADER field 753 are positioned before other data in the sequence. After information indicating the sequence, an ENTRY_SC field 755 and an ENTRY_HEADER field 757 are positioned in order to distinguish a GOP and to support random access. After these fields, data 773 corresponding to a plurality of frame images of a main image are positioned. Data corresponding to each frame image is formed with a FRAME_SC field 759, a FRAME_DATA field 761, an AUXILIARY_SC field 763, and an AUXILIARY_DATA field 765. Here, in relation to one frame image of a main image, the auxiliary image can be formed with a plurality of frame images 767. Meanwhile, according to a need of a user, or a request of the decoding apparatus, or the situation in a transmission channel, the auxiliary image 769 may be omitted. After one GOP is constructed, other existing GOPs 773 are repeatedly constructed. Also, after one sequence is constructed, other existing sequences 775 are repeatedly constructed.

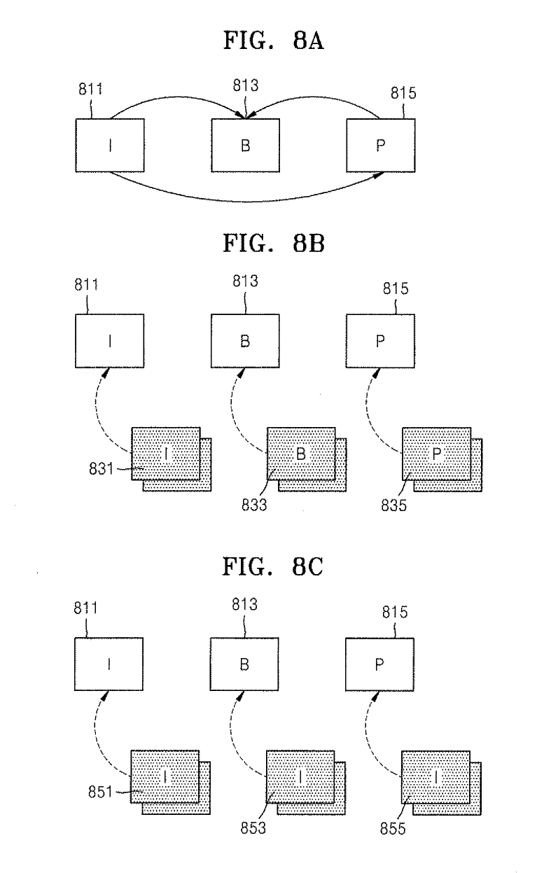

FIGS. 8A through 8C are diagrams illustrating relations between main images and auxiliary images that are frame images according to an embodiment of the present invention. FIG. 8A is a diagram illustrating relations between I, B, and P frame images 811, 813, and 815. An I frame image 811 is encoded or decoded using a block spatially adjacent to an encoding block in the I frame image 811, for prediction, without referring to other images. After the I frame image 811, a P frame image 815 is encoded or decoded through motion prediction from a previous predictable image. Then, a B frame image 813 is encoded or decoded through motion prediction from two predictable images before or after the B frame image 813.

FIG. 8B is a diagram illustrating I, B, and P frame images 831, 833, and 835 as auxiliary images corresponding to the I, B, and P frame images 811, 813, and 815 that are main images. Between I, B, and P frame images 831, 833, and 835 that are auxiliary images, prediction encoding or prediction decoding is performed according to the same method as used in the main images.

FIG. 8C is a diagram illustrating a case where auxiliary images corresponding to the I, B, and P frame images 811, 813, and 815 that are main images, are all I frame images 851, 853, and 855, regardless of the prediction encoding method of the main images. This is defined considering a case where similarities between adjacent auxiliary images are weak unlike the similarities between main images.

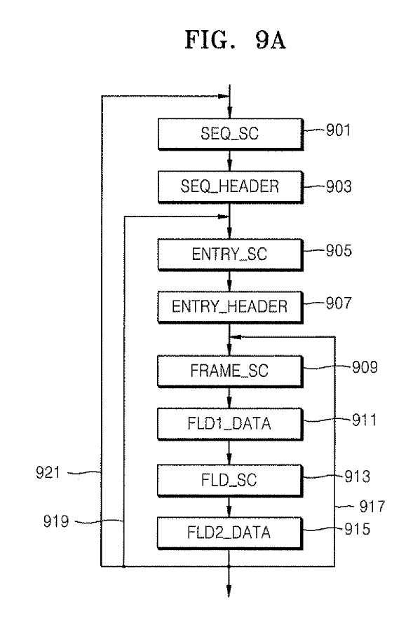

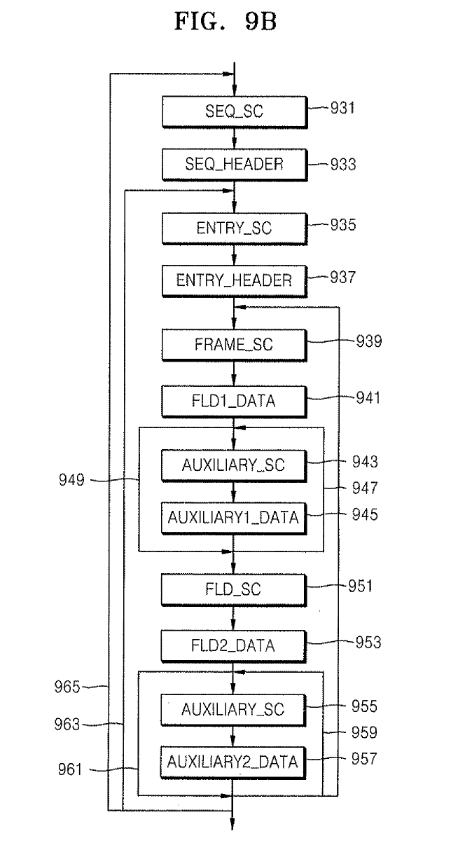

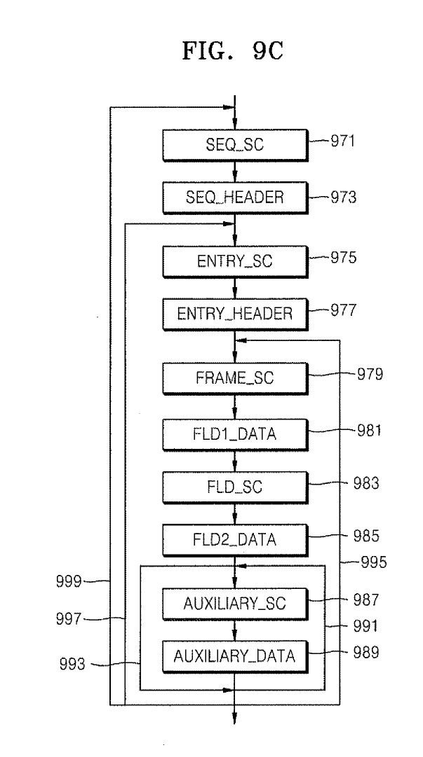

FIGS. 9A through 9C illustrate structures of a bitstream generated in the bitstream packing unit 150 illustrated in FIG. 1. FIG. 9A is a diagram illustrating a structure of a first bitstream generated as a result of encoding a field-type main image without an auxiliary image. FIG. 9B is a diagram illustrating a structure of a second bitstream generated as a result of encoding a field-type main image with an auxiliary image according to an embodiment of the present invention. FIG. 9C is a diagram illustrating a structure of a second bitstream generated as a result of encoding a field-type main image with an auxiliary image according to another embodiment of the present invention.

In the structure of the first bitstream illustrated in FIG. 9A, a SEQ_SC field 901 and a SEC_HEADER field 903 are positioned before other data in the sequence. After information indicating the sequence, an ENTRY_SC field 905 and an ENTRY_HEADER field 907 are positioned. After these fields, data 917 corresponding to a plurality of frame images of a main image are positioned. Data corresponding to each frame image is formed with a FRAME_SC field 909, an FLD1_DATA field 911 corresponding to first field data, an FLD_SC field 913 to distinguish the first field and a second field, and an FLD2_DATA field 915 corresponding to second field data. After one GOP is constructed, other existing GOPs 919 are repeatedly constructed. Also, after one sequence is constructed, other existing sequences 921 are repeatedly constructed.

Meanwhile, in order to construct the second bitstream by including the auxiliary image into the structure of the first bitstream, in the structure of the second bitstream illustrated in FIG. 9B, auxiliary image data is positioned after each field data of a main image, i.e., an FLD1_DATA field 941 and an FLD2_DATA field 953. That is, after the first field data of the main image, an AUXILIARY_SC field 943 and an AUXILIARY_DATA field 945 that are auxiliary image data are positioned, and after the second field data of the main image, an AUXILIARY_SC field 955 and an AUXILIARY_DATA field 957 are positioned. In the same manner, in relation to one field image of the main image, auxiliary images may be formed with a plurality of images 947 and 959. Meanwhile, according to a need of a user, or a request of the decoding apparatus, or the situation in a transmission channel, the auxiliary images 949 and 961 may be omitted.

Also, in order to construct the second bitstream by including the auxiliary image into the structure of the first bitstream, in the structure of the second bitstream illustrated in FIG. 9C, auxiliary image data is positioned after the second field data of the main image, i.e., an FLD2_DATA field 985. That is, after the second field data of the main image, an AUXILIARY_SC field 987 and an AUXILIARY_DATA field 989 that are auxiliary image data corresponding a frame image of a main image formed with two field images are positioned. In the same manner, in relation to one field image of the main image, auxiliary images may be formed with a plurality of images 991. Meanwhile, according to a need of a user, or a request of the decoding apparatus, or the situation in a transmission channel, the auxiliary images 993 may be omitted.

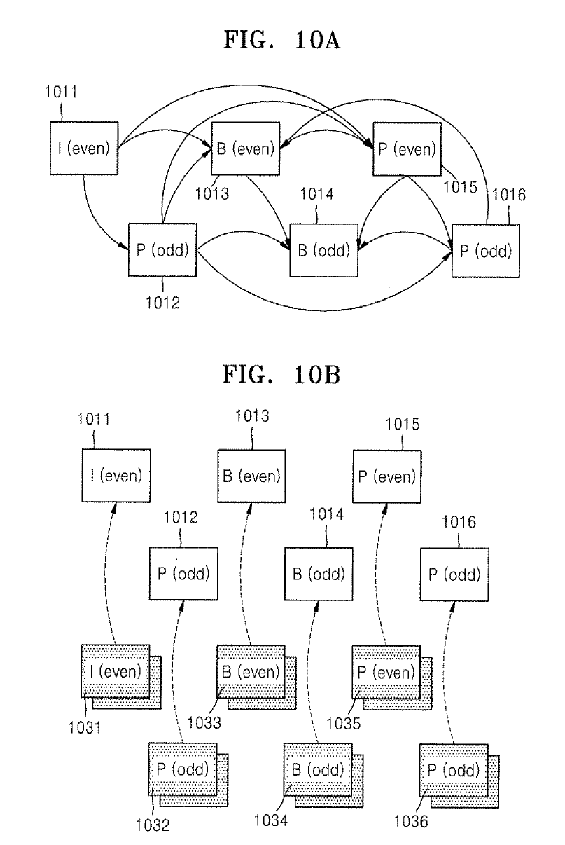

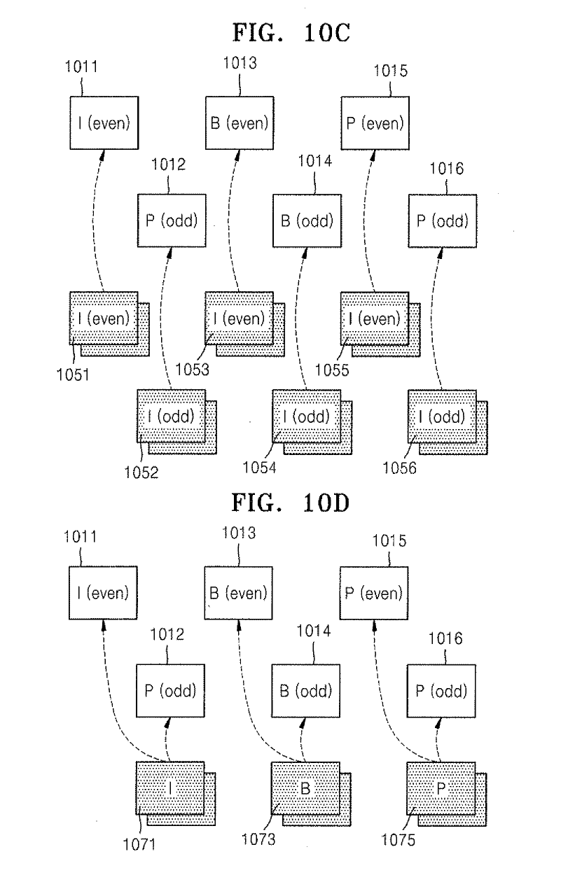

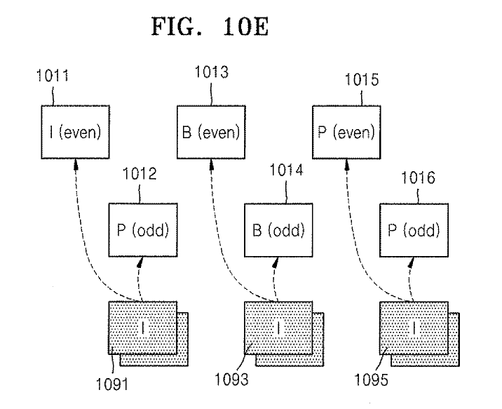

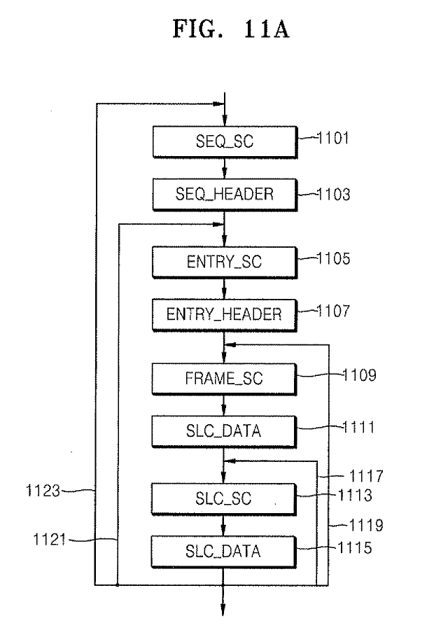

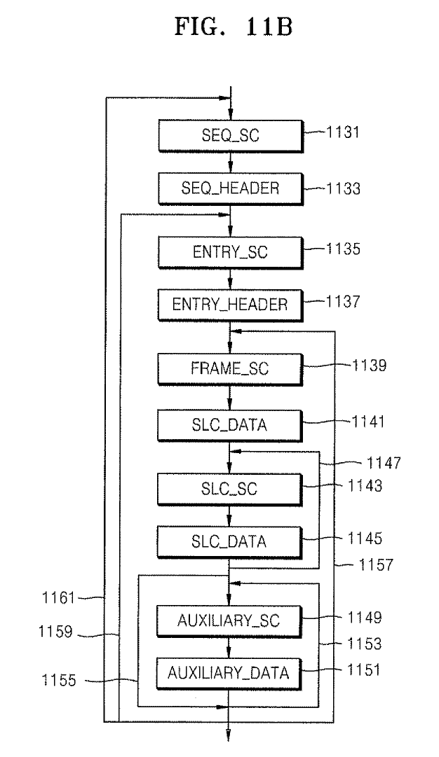

FIGS. 10A through 10E are diagrams illustrating relations between field-type main images and auxiliary images according to an embodiment of the present invention. FIG. 10A illustrates the relations between I, B, and P field images 1011 through 1016 using a prediction encoding method. Among field images forming a frame, I field image 1011 that is an even field is first encoded. Then, an odd field is encoded as a P field image 1012. Without referring to another image, an I field image is encoded by using a block spatially adjacent to an encoding block in the image. A P field image is encoded by performing motion prediction from two temporally adjacent previous reference field images. For the P field image 1015, motion prediction is performed using the I field image 1011 and the P field image 1012. For the P field image 1016, motion prediction is performed using the P field image 1012 and the P field image 1015. Among odd fields, the P field image 1012 has only one reference field image, and is encoded by performing motion prediction using the I field image 1011. A B field image is encoded by performing motion prediction from two field images that are temporally closest to the field image before and after the field image, and predictable. In particular, in the case of the B field image of the second field in one frame, the B field image of the restored first field is also used for motion prediction encoding. For the B field image 1013 of the first field of a frame image, motion prediction is performed using the I field image 1011 and the P field image 1012 before the B field image 1013, and the P field images 1015 and 1016 after the B field image 1013. For the B field image 1014 of the second field, motion prediction is performed using the P field image 1012 and the B field image 1013 before the B field image 1014, and the P field images 1015 and 1016 after the B field image 1014.

FIG. 10B illustrates an I field image 1031, B field images 1033 and 1034, and P field images 1032, 1035, and 1036 that are auxiliary images corresponding to an I field image 1011, B field images 1013 and 1014, and P field images 1012, 1015, and 1016 that are main images. Also between I, B, and P field images 1031 through 1036 that are auxiliary images, prediction encoding or prediction decoding is performed according to the same method as used in the main images.

FIG. 10C illustrates a case where auxiliary images corresponding to the I, B, and P field images 1011 through 1016 are I field images 1051 through 1056. This is defined considering a case where similarities between adjacent auxiliary images are weak unlike the similarities between main images.

FIG. 10D illustrates a case where an auxiliary image is made to correspond to a frame image formed with two field images of a main image instead of one field image of the main image. The I field image 1071 that is an auxiliary image corresponds to a frame image formed with two field images 1011 and 1012. The P and B images 1073 and 1075 that are auxiliary images correspond to frame images in the same manner. This is because an auxiliary image does not need to be encoded or decoded in units of fields if the auxiliary image is for editing or synthesizing.

FIG. 10E illustrates a case where regardless of the prediction encoding method of a main image, auxiliary images corresponding to frame images that are main images are all I images 1091, 1093, and 1095. This is also defined considering a case where similarities between adjacent auxiliary images are weak unlike the similarities between main images.

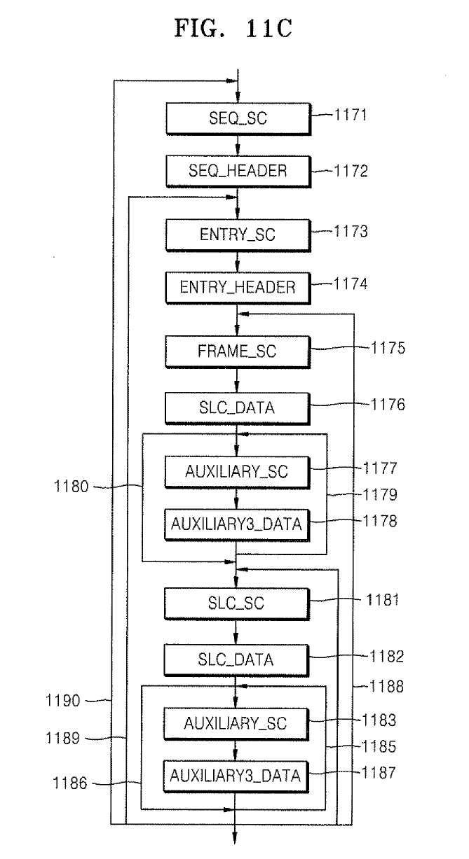

FIGS. 11A through 11C are diagrams illustrating structures of bitstreams generated by the bitstream packing unit 150 illustrated in FIG. 1. FIG. 11A is a diagram illustrating a structure of a first bitstream generated as a result of encoding a slice-type main image without an auxiliary image. FIG. 11B is a diagram illustrating a structure of a second bitstream generated as a result of encoding a slice-type main image with an auxiliary image according to an embodiment of the present invention. FIG. 11C is a diagram illustrating a structure of a third bitstream generated as a result of encoding a slice-type main image with an auxiliary image according to another embodiment of the present invention.

Referring to the structure of the first bitstream illustrated in FIG. 11A, a SEQ_SC field 1101 and a SEC_HEADER field 1103 are positioned before other data in the sequence. After information indicating the sequence, an ENTRY_SC field 1105 and an ENTRY_HEADER field 1107 are positioned. After these fields, data 1119 corresponding to a plurality of frame images of a main image are positioned. Data corresponding to each frame image is formed with a FRAME_SC field 1109, an SLC_DATA field 1111 corresponding to a first slice, an SLC_SC field 1113 to distinguish the first slice from the second slicer and an SLC_DATA Field 1115 corresponding to the second slice data. Until one frame image or one field image is constructed, SLC_SC fields and SLC_DATA fields for a plurality of slices 1117 exist. After a GOP is constructed, other existing GOPs 1121 are repeatedly constructed. Also, after one sequence is constructed, other existing sequences 1123 are repeatedly constructed.

Meanwhile, in order to construct the second bitstream by including an auxiliary image into the structure of the first bitstream, in the structure of the second bitstream illustrated in FIG. 11B, after the last slice data of the main image, i.e., an SLC_DATA field 1145, auxiliary image data is positioned. That is, after the last slice data of the main image, an AUXILIARY_SC field 1149 and an AUXILIARY1_DATA field 1151 that are auxiliary image data are positioned. In the same manner, in relation to one frame image of the main image, auxiliary images may be formed with a plurality of images 1153. Meanwhile, according to a need of a user, or a request of the decoding apparatus, or the situation in a transmission channel, the auxiliary images 1155 may be omitted.

Also, in order to construct the second bitstream by including the auxiliary image into the structure of the first bitstream, in the structure of the second bitstream illustrated in FIG. 11C, auxiliary image data is positioned after each slice data of the main image, i.e., an SLC_DATA field 1176 and 1182. That is, after the first slice data of the main image, an AUXILIARY_SC field 1177 and an AUXILIARY3_DATA field 1178 that are auxiliary image data are positioned. In the same manner, in relation to one slice of the main image, auxiliary images may be formed with a plurality of images 1179. Meanwhile, according to a need of a user, or a request of the decoding apparatus, or the situation in a transmission channel, the auxiliary images 1180 may be omitted. Also, after the second slice data of the main image, an AUXILIARY_SC field 1183 and an AUXILIARY3_DATA field 1187 that are auxiliary image data are positioned. In the same manner, in relation to one slice of the main image, auxiliary images may be formed with a plurality of images 1185. Meanwhile, according to a need of a user, or a request of the decoding apparatus, or the situation in a transmission channel, the auxiliary images 1186 may be omitted.

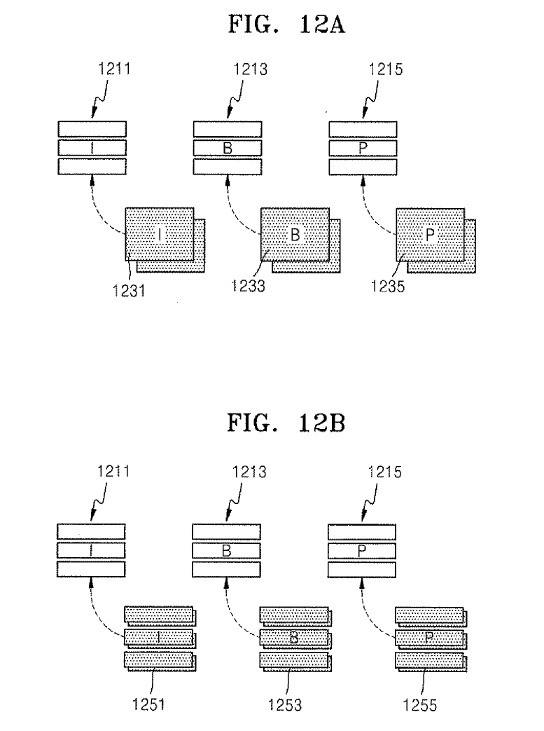

FIGS. 12A and 12B are diagrams illustrating relations between slice-type main images and auxiliary images according to an embodiment of the present invention. FIG. 12A is a diagram illustrating that an I image 1231, a B image 1233, and a P image 1235 that are auxiliary images are made to correspond to each slices of an I image 1211, a B image 1213 and a P image 1215 formed with slices. Here, the auxiliary image is not a slice-unit image but a single image.

FIG. 12B is a diagram illustrating that slices of an I image 1251, a B image 1253, and a P image 1255 that are auxiliary images are made to correspond to slices of an I image 1211, a B image 1213 and a P image 1215 an I image 10101, a B image 10102 and a P image 10103 formed with slices. Here, each slice of the auxiliary image has the same size as that of a corresponding slice of the main image.

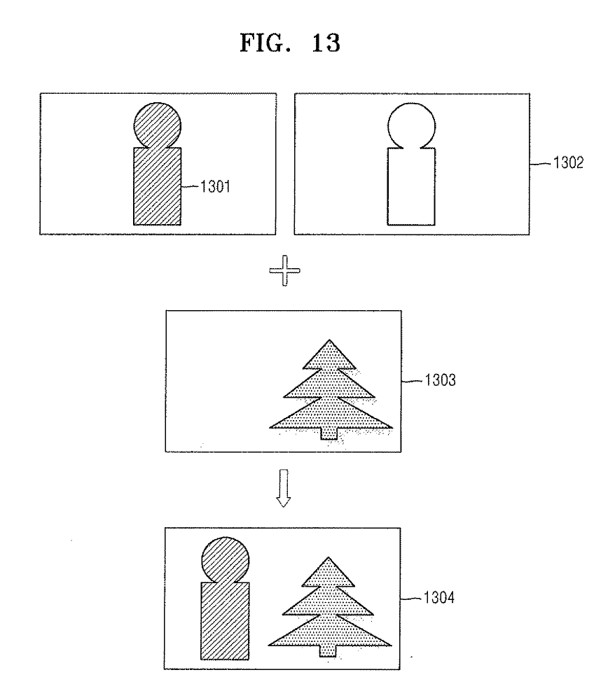

FIG. 13 is a diagram illustrating an example of image synthesis using a gray alpha image as an example of an auxiliary image according to an embodiment of the present invention. Reference number 1301 indicates a foreground region having luminance and chrominance components, and reference number 1302 indicates an auxiliary image having a gray alpha component to indicate this foreground region. By using this gray alpha component, the foreground region 1301 is synthesized with a first image 1303 having arbitrary luminance and chrominance components, and as the result of the synthesis, a different second image 1304 can be obtained. This process can be used when a new background image is made by synthesizing a predetermined region of an image with another image in a process of editing digital contents for broadcasting. If it is assumed that the luminance and chrominance components of the foreground region 1301 are N_{yuv}, the corresponding gray alpha component is N_{α}, and the luminance and chrominance components of the first image 1303 are M_{yuv}, the luminance and chrominance components P_{yuv} can be expressed as equation 1 below:

P_{yuv}=((2ⁿ−1−N_{α})×M_{yuv}+(N_{α}×N_{yuv}))/(2ⁿ−1) (1)

The gray alpha component N_{α} is expressed as n bits, and, for example, in the case of 8 bits, it has a value from 0 to 255. As illustrated in equation 1, the gray alpha component is used as a weight value in order to obtain a weighted mean value between the luminance and chrominance components of two images. Accordingly, when the gray alpha component is ‘0’, it indicates a background region and the luminance and chrominance components of the background region do not affect a synthesized second image regardless of the values of the components.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention as described above, when a gray alpha image, a depth image or an image identical to a main image is set as an auxiliary image, the auxiliary image is encoded according the same encoding scheme as used for the main image, and by combining the encoded main image and encoded auxiliary image, a bitstream can be packed. As a result, a separate bitstream for an auxiliary image does not need to be generated and compatibility with conventional video encoding apparatus and decoding apparatus can be provided. Also, the auxiliary image for authoring broadcasting or digital contents can be conveniently transmitted together with the main image.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for encoding a video comprising:
an encoding unit encoding a main image and an auxiliary image and generating encoded main image data and encoded auxiliary image data; and
a bitstream packing unit combining the encoded auxiliary image data to the encoded main image data and thus packing the data as one bitstream.

2. The apparatus of claim 1, wherein according to an external control signal, the bitstream packing unit determines whether or not to combine the encoded main image data and the encoded auxiliary image data.

3. The apparatus of claim 1, wherein the auxiliary image is any one of a gray alpha image, a depth image, and an image identical to the main image.

4. The apparatus of claim 1, wherein in the encoding unit encoding of the luminance signal with respect to the auxiliary image is performed.

5. The apparatus of claim 1, wherein in order to combine the encoded auxiliary image data with the encoded main image data, the bitstream packing unit defines a first field indicating a signal for identifying the auxiliary image, header information in relation to the auxiliary image, and a second field indicating the encoded data of the auxiliary image.

6. The apparatus of claim 1, wherein if the main image is a frame image, the bitstream packing unit positions the encoded auxiliary image data after the encoded frame image data.

7. The apparatus of claim 6, wherein the main image and the auxiliary image are encoded according to an identical prediction encoding method.

8. The apparatus of claim 6, wherein the auxiliary image is formed only with an I frame image.

9. The apparatus of claim 1, wherein if the main image is a field image, the bitstream packing unit positions the encoded auxiliary image data after encoded even field image data and encoded odd field image data, respectively.

10. The apparatus of claim 9, wherein the main image and the auxiliary image are encoded according to an identical prediction encoding method.

11. The apparatus of claim 9, wherein the auxiliary image is formed only with an I field image or an I frame image.

12. The apparatus of claim 1, wherein if the main image is a field image, the bitstream packing unit positions the encoded auxiliary image data after one field image data of the encoded even field image data and the encoded odd field image data, the one field image data being positioned after the other field image data.

13. The apparatus of claim 12, wherein the main image and the auxiliary image are encoded according to an identical prediction encoding method.

14. The apparatus of claim 12, wherein the auxiliary image is formed only with an I field image or an I frame image.

15. The apparatus of claim 1, wherein if the main image is formed with slices, the bitstream packing unit positions the encoded auxiliary image data after last encoded slice data.

16. The apparatus of claim 15, wherein the main image and the auxiliary image are encoded according to an identical prediction encoding method, and the auxiliary image is a frame image or a field image.

17. The apparatus of claim 15, wherein the main image and the auxiliary image are encoded according to an identical prediction encoding method, and the auxiliary image is formed with slices identical to those of the main image.

18. The apparatus of claim 1, wherein if the main image is formed with slices, the bitstream packing unit positions the encoded auxiliary image data after each encoded slice data.

19. The apparatus of claim 18, wherein the main image and the auxiliary image are encoded according to an identical prediction encoding method, and the auxiliary image is a frame image or a field image.

20. The apparatus of claim 18, wherein the main image and the auxiliary image are encoded according to an identical prediction encoding method, and the auxiliary image is formed with slices identical to those of the main image.

21. A method of encoding a video comprising:
encoding a main image and an auxiliary image and generating encoded main image data and encoded auxiliary image data; and
according to an external control signal, determining whether or not to combine the encoded main image data with the encoded auxiliary image data, and packing the data as one bitstream.

22. The method of claim 21, wherein the auxiliary image is any one of a gray alpha image, a depth image, and an image identical to the main image.

23. The method of claim 21, wherein in the encoding of the main image and auxiliary image, encoding of a luminance signal with respect to the auxiliary image is performed.

24. The method of claim 21, wherein in the packing of the bitstream, in order to combine the encoded auxiliary image data with the encoded main image data, a first field indicating a signal for identifying the auxiliary image, header information in relation to the auxiliary image, and a second field indicating the encoded data of the auxiliary image are defined.

25. An apparatus for decoding a video comprising:
a bitstream unpacking unit unpacking a bitstream packed by combining encoded auxiliary image data to encoded main image data, and separating the encoded main image data and the encoded auxiliary image data; and
a decoding unit decoding the separated encoded main image data and auxiliary image data and generating a restored image.

26. The apparatus of claim 25, wherein the auxiliary image is any one of a gray alpha image, a depth image, and an image identical to the main image.

27. The apparatus of claim 25, wherein in the decoding unit, decoding of a luminance signal with respect to the auxiliary image is performed.

28. The apparatus of claim 25, wherein in order to combine the encoded auxiliary image data with the encoded main image data, the bitstream unpacking unit separates the encoded main image data and the encoded auxiliary image data, by using a first field indicating a signal for identifying the auxiliary image, header information in relation to the auxiliary image, and a second field indicating the encoded data of the auxiliary image.

29. A method of decoding a video comprising:
unpacking a bitstream packed by combining encoded auxiliary image data to encoded main image data, and separating the encoded main image data and the encoded auxiliary image data; and
decoding the separated encoded main image data and auxiliary image data and generating a restored image.

30. The method of claim 29, wherein the auxiliary image is any one of a gray alpha image, a depth image, and an image identical to the main image.

31. The method of claim 29, wherein in the decoding of the data, decoding of a luminance signal with respect to the auxiliary image is performed.

32. The method of claim 28, wherein in the unpacking of the bitstream, in order to combine the encoded auxiliary image data with the encoded main image data, the encoded main image data and the encoded auxiliary image data are separated using a first field indicating a signal for identifying the auxiliary image, header information in relation to the auxiliary image, and a second field indicating the encoded data of the auxiliary image.

33. A computer readable recording medium having embodied thereon a computer program for executing the method of encoding a video wherein the method comprises:
encoding a main image and an auxiliary image and generating encoded main image data and encoded auxiliary image data; and
according to an external control signal, determining whether or not to combine the encoded main image data with the encoded auxiliary image data, and packing the data as one bitstream.

34. A computer readable recording medium having embodied thereon a computer program for executing the method of decoding a video wherein the method comprises:
unpacking a bitstream packed by combining encoded auxiliary image data to encoded main image data, and separating the encoded main image data and the encoded auxiliary image data; and
decoding the separated encoded main image data and auxiliary image data and generating a restored image.
